(19) United States
(12) Patent Application Publication
(10) Pub. No.: US 2026/0233528 A1
(43) Pub. Date: Aug. 13, 2026

(54) RECORDING APPARATUS AND CONTROL METHOD THEREOF

(71) Applicant: SEIKO EPSON CORPORATION, TOKYO (JP)

(72) Inventors: Takao OIZUMI, MATSUMOTO-SHI (JP); Akira NAKAZAWA, AZUMINO-SHI (JP); Shingo WAKI, MATSUMOTO-SHI (JP); Hiroki CHINO, MATSUMOTO-SHI (JP)

(21) Appl. No.: 19/534,953

(22) Filed: Feb. 10, 2026

(30) Foreign Application Priority Data
Feb. 10, 2025 (JP) 2025-019841

(51) Int. Cl. B41J 2/165; B41J 2/045

(52) U.S. Cl. CPC B41J 2/16508; B41J 2/04586; B41J 2/16526; B41J 2/16532

(57) ABSTRACT

A recording apparatus according to the present disclosure includes an ejection unit that ejects a liquid onto a medium, a supply unit that supplies the liquid from a liquid container to the ejection unit, a first detection unit that detects that an amount of the liquid inside the liquid container or inside the supply unit falls below a predetermined amount, and a control unit that controls the ejection unit. The control unit can execute a first mode in which ejection of the liquid onto the medium by the ejection unit is restricted when the first detection unit detects the fact indicating that the amount of the liquid falls below the predetermined amount, and a second mode in which the ejection of the liquid onto the medium by the ejection unit is not restricted until the ejection unit cannot eject the liquid.

The present application is based on, and claims priority from JP Application Serial Number 2025-019841, filed February 10, 2025, the disclosure of which is hereby incorporated by reference herein in its entirety.

### BACKGROUND

### 1. Technical Field

The present disclosure relates to a recording apparatus and a control method thereof.

### 2. Related Art

Examples of the related art of an apparatus of such a type include an apparatus disclosed in JP-A-2013-107367.

JP-A-2013-107367 discloses an image forming apparatus configured to continue printing by replacing printing with ink of another color when a detection unit detects that an ink remaining amount in an ink supply unit is zero.

JP-A-2013-107367 is an example of the related art.

However, even when an ink remaining amount in the ink supply unit becomes zero, ink often remains downstream of a portion where the ink remaining amount is detected, such as in a head. There is room for improvement from the viewpoint of continuity of printing in an emergency.

### SUMMARY

In order to solve the above problems, a recording apparatus according to the present disclosure is a recording apparatus that performs recording by ejecting a liquid onto a medium. The recording apparatus includes: an ejection unit configured to eject the liquid onto the medium; a supply unit configured to supply the liquid from a liquid container to the ejection unit; a first detection unit configured to detect that an amount of the liquid inside the liquid container or inside the supply unit falls below a predetermined amount; and a control unit configured to control the ejection unit, in which the control unit is configured to execute a first mode in which ejection of the liquid onto the medium by the ejection unit is restricted when the first detection unit detects the fact indicating that the amount of the liquid falls below the predetermined amount, and a second mode in which the ejection of the liquid onto the medium by the ejection unit is not restricted until the ejection unit becomes unable to eject the liquid.

A control method of a recording apparatus according to the present disclosure is a control method of a recording apparatus that performs recording by ejecting a liquid onto a medium and that includes an ejection unit configured to eject the liquid onto the medium, a supply unit configured to supply the liquid from a liquid container to the ejection unit, and a first detection unit configured to detect that an amount of the liquid inside the liquid container or inside the supply unit falls below a predetermined amount. The control method includes: executing a first mode in which ejection of the liquid onto the medium by the ejection unit is restricted when the first detection unit detects the fact indicating that the amount of the liquid falls below the predetermined amount; and executing a second mode in which the ejection of the liquid onto the medium by the ejection unit is not restricted until the ejection unit becomes unable to eject the liquid.

### BRIEF DESCRIPTION OF THE DRAWINGS

FIG. 1 is a schematic configuration diagram illustrating a recording apparatus according to Embodiment 1.

FIG. 2 is a block diagram illustrating a configuration of a control unit according to Embodiment 1.

FIG. 3 is a flowchart illustrating a control flow of the control unit according to Embodiment 1.

FIG. 4 is a schematic configuration diagram illustrating a recording apparatus according to Embodiment 2.

FIG. 5 is a block diagram illustrating a configuration of a control unit according to Embodiment 2.

FIG. 6 is a flowchart illustrating a control flow of the control unit according to Embodiment 2.

### DESCRIPTION OF EMBODIMENTS

First, an overview of the present disclosure will be described.

In order to solve the above problems, a recording apparatus according to a first aspect of the present disclosure is a recording apparatus that performs recording by ejecting a liquid onto a medium. The recording apparatus includes: an ejection unit configured to eject the liquid onto the medium; a supply unit configured to supply the liquid from a liquid container to the ejection unit; a first detection unit configured to detect that an amount of the liquid inside the liquid container or inside the supply unit falls below a predetermined amount; and a control unit configured to control the ejection unit, in which the control unit is configured to execute a first mode in which ejection of the liquid onto the medium by the ejection unit is restricted when the first detection unit detects the fact indicating that the amount of the liquid falls below the predetermined amount, and a second mode in which the ejection of the liquid onto the medium by the ejection unit is not restricted until the ejection unit becomes unable to eject the liquid.

Here, the "predetermined amount" in "when the first detection unit detects the fact indicating that the amount of the liquid falls below the predetermined amount" is a remaining amount of the liquid that is set in advance so as not to bring the ejection unit into an idle ejection state. In the idle ejection state, that is, when the amount of the liquid decreases to such an extent that the ejection unit cannot eject the liquid, a failure risk of the ejection unit increases, and thus such a "predetermined amount" is set in advance.

In addition, "restricted" in "the ejection of the liquid onto the medium by the ejection unit is restricted" refers to notifying a user that the liquid needs to be replenished, and when the liquid is not replenished thereafter, the liquid is not allowed to be ejected before the idle ejection state.

According to the present aspect, the control unit can execute the first mode in a regular state. In the first mode, when the first detection unit detects the fact indicating that the amount of the liquid falls below the predetermined amount, the ejection of the liquid onto the medium by the ejection unit is restricted. In a regular state, it is possible to reduce a risk of failure occurrence of the ejection unit by restricting the ejection of the liquid when the liquid amount falls below the predetermined amount.

Meanwhile, the control unit can execute the second mode. In the second mode, the ejection of the liquid onto the medium by the ejection unit is not restricted until the ejection unit cannot eject the liquid. That is, the second mode is a mode in which it is possible to continue printing until the ejection unit enters the idle ejection state when it is desired to continue the recording, that is, the printing even when the risk of the failure occurrence of the ejection unit is allowed, for example, in an emergency. Accordingly, the continuity of printing can be increased by setting the second mode in an emergency or the like.

The recording apparatus according to a second aspect of the present disclosure is an aspect according to the first aspect, in which the ejection unit is configured to eject liquids of multiple colors, and the control unit causes the ejection unit to eject, among the liquids of multiple colors, a liquid of a second color onto the medium instead of a liquid of a first color, in the second mode, when the ejection unit becomes unable to eject the liquid of the first color.

According to the present aspect, the control unit is configured to cause, in the second mode, the ejection unit to eject, among the liquids of multiple colors, the liquid of the second color onto the medium instead of the liquid of the first color when the ejection unit cannot eject the liquid of the first color. That is, when the ejection unit cannot eject the liquid of the first color among the liquids of multiple colors, the ejection unit continues to eject the liquid of the second color until the ejection unit enters the idle ejection state. In a case where there is a liquid of a third color, when the ejection unit enters the idle ejection state for the liquid of the second color, the ejection unit continues to eject the liquid of the third color until the ejection unit enters the idle ejection state.

In other words, the liquids of multiple colors are configured to be used up until the ejection unit enters the idle ejection state for the liquids of multiple colors one by one. Accordingly, since all of the liquids of multiple colors are used up until the ejection unit enters the idle ejection state, it is possible to improve the continuity of printing in an emergency or the like.

The recording apparatus according to a third aspect of the present disclosure is an aspect according to the first aspect, in which the ejection unit is configured to eject liquids of multiple colors, and the control unit causes, in the second mode, the ejection unit to eject, among the liquids of multiple colors, a liquid of a second color and a liquid of a third color onto the medium instead of a liquid of a first color when the ejection unit becomes unable to eject the liquid of the first color.

According to the present aspect, the control unit is configured to cause, in the second mode, the ejection unit to eject, among the liquids of multiple colors, the liquid of the second color and the liquid of the third color onto the medium instead of the liquid of the first color when the ejection unit cannot eject the liquid of the first color. In a case where there is a liquid of a fourth color, when the ejection unit enters the idle ejection state for the liquid of the second color, the ejection unit may continue to eject the liquid of the third color and the liquid of the fourth color onto the medium. When the ejection unit enters the idle ejection state for the liquid of the second color and the liquid of the third color, the ejection unit may continue to eject the liquid of the fourth color until the ejection unit enters the idle ejection state.

Accordingly, since all of the liquids of multiple colors are used up until the ejection unit enters the idle ejection state, it is possible to improve the continuity of printing in an emergency or the like.

In addition, even when the liquid of the second color alone is a color having low visibility with respect to a ground color of the medium, that is, a color that is less likely to be seen, since the ejection unit ejects the liquid of the second color and the liquid of the third color onto the medium, it is possible to prevent a decrease in visibility as compared with a case of a single color. That is, since the liquid of the second color and the liquid of the third color are mixed on the medium, it is possible to prevent a decrease in the visibility as compared with a case of a single color. In addition, it is possible to prevent a specific color from decreasing first.

The recording apparatus according to a fourth aspect is an aspect according to the first aspect, in which the ejection unit is configured to eject liquids of multiple colors, and the control unit causes, in the second mode, the ejection unit to eject, among the liquids of multiple colors, a liquid of a second color onto the medium instead of a liquid of a first color when the first detection unit detects that an amount of the liquid of the first color falls below the predetermined amount.

According to the present aspect, the control unit is configured to cause, in the second mode, the ejection unit to eject, among the liquids of multiple colors, the liquid of the second color onto the medium instead of the liquid of the first color when the first detection unit detects that an amount of the liquid of the first color falls below the predetermined amount. In a case where there is a liquid of a third color, when the first detection unit detects that an amount of the liquid of the second color falls below the predetermined amount, the ejection unit is caused to eject the liquid of the third color.

Since the ejection unit is caused to eject the liquid of the second color onto the medium in a state where the liquid of the first color remains, it is possible to reduce a risk of failure occurrence of the ejection unit as compared with a case where the liquid of the first color is used up until the ejection unit enters the idle ejection state and then the liquid of the second color is ejected instead. That is, after the first detection unit detects the fact indicating that the amount of the liquid of the first color falls below the predetermined amount, it is possible to delay a timing at which the liquid of the first color is ejected until the ejection unit enters the idle ejection state, and thus it is possible to reduce the risk of failure occurrence of the ejection unit.

The recording apparatus according to a fifth aspect is an aspect according to the first aspect, in which the ejection unit is configured to eject liquids of multiple colors, and the control unit causes, in the second mode, the ejection unit to eject, among the liquids of multiple colors, a liquid of a second color and a liquid of a third color onto the medium instead of a liquid of a first color when the first detection unit detects that an amount of the liquid of the first color falls below the predetermined amount.

According to the present aspect, the control unit is configured to cause, in the second mode, the ejection unit to eject, among the liquids of multiple colors, the liquid of the second color and the liquid of the third color onto the medium instead of the liquid of the first color when the first detection unit detects that an amount of the liquid of the first color falls below the predetermined amount. In a case where there is a liquid of a fourth color, when the first detection unit detects that an amount of the liquid of the second color falls below the predetermined amount, the ejection unit may be caused to eject the liquid of the third color and the liquid of the fourth color.

Since the ejection unit is caused to eject the liquid of the second color and the liquid of the third color onto the medium in a state where the liquid of the first color remains, it is possible to reduce a risk of failure occurrence of the ejection unit as compared with a case where the liquid of the first color is used up until the ejection unit enters the idle ejection state and then the liquid of the second color and the liquid of the third color are ejected instead. That is, after the first detection unit detects the fact indicating that the amount of the liquid of the first color falls below the predetermined amount, it is possible to delay a timing at which the liquid of the first color is ejected until the ejection unit enters the idle ejection state, and thus it is possible to reduce the risk of failure occurrence of the ejection unit.

In addition, even when the liquid of the second color alone is a color having low visibility with respect to a ground color of the medium, that is, a color that is less likely to be seen, since the ejection unit ejects the liquid of the second color and the liquid of the third color onto the medium, it is possible to prevent a decrease in visibility as compared with a case of a single color. That is, since the liquid of the second color and the liquid of the third color are mixed on the medium, it is possible to prevent a decrease in the visibility as compared with a case of a single color. In addition, it is possible to prevent a specific color from decreasing first.

The recording apparatus according to a sixth aspect of the present disclosure is an aspect according to the first aspect, in which the ejection unit is configured to eject liquids of multiple colors, and the control unit causes, in the second mode, the ejection unit to eject a liquid of a second color onto the medium instead of a liquid of a first color when the first detection unit detects that liquid amounts of the liquids of all the colors fall below the predetermined amount and further the ejection unit becomes unable to eject the liquid of the first color.

According to the present aspect, the control unit causes, in the second mode, the ejection unit to eject the liquid of the first color until the ejection unit cannot eject the liquid of the first color when the first detection unit detects the fact indicating that the liquid amounts of the liquids of all the colors fall below the predetermined amount. That is, the ejection of the liquid of the first color until the idle ejection state is not performed until the liquid amounts of the liquids of all the colors fall below the predetermined amount. Accordingly, it is possible to reduce the risk of failure occurrence of the ejection unit.

In addition, when the ejection unit cannot eject the liquid of the first color, the ejection unit is caused to eject the liquid of the second color onto the medium instead of the liquid of the first color. In a case where there is a liquid of a third color, when the ejection unit enters the idle ejection state for the liquid of the second color, the ejection unit continues to eject the liquid of the third color until the ejection unit enters the idle ejection state.

Accordingly, since all of the liquids of multiple colors are used up until the ejection unit enters the idle ejection state, it is possible to improve the continuity of printing in an emergency or the like.

The recording apparatus according to a seventh aspect of the present disclosure is an aspect according to the first aspect, in which the ejection unit is configured to eject liquids of multiple colors, and the control unit causes the ejection unit to eject a liquid of a second color and a liquid of a third color onto the medium instead of a liquid of a first color when the first detection unit detects that liquid amounts of the liquids of all the colors fall below the predetermined amount and the ejection unit becomes unable to eject the liquid of the first color in the second mode.

According to the present aspect, the control unit is configured to cause the ejection unit to eject the liquid of the first color until the ejection unit cannot eject the liquid of the first color when the first detection unit detects the fact indicating that the liquid amounts of the liquids of all the colors fall below the predetermined amount in the second mode. That is, the ejection of the liquid of the first color until the idle ejection state is not performed until the liquid amounts of the liquids of all the colors fall below the predetermined amount. Accordingly, it is possible to reduce the risk of failure occurrence of the ejection unit.

In addition, when the ejection unit cannot eject the liquid of the first color, the ejection unit is caused to eject the liquid of the second color and the liquid of the third color onto the medium instead of the liquid of the first color. In a case where there is a liquid of a fourth color, when the ejection unit enters the idle ejection state for the liquid of the second color, the ejection unit may eject the liquid of the third color and the liquid of the fourth color onto the medium. When the ejection unit enters the idle ejection state for the liquid of the second color and the liquid of the third color, the ejection unit may continue to eject the liquid of the fourth color until the ejection unit enters the idle ejection state. Accordingly, since all of the liquids of multiple colors are used up until the ejection unit enters the idle ejection state, it is possible to improve the continuity of printing in an emergency or the like.

In addition, even when the liquid of the second color alone is a color having low visibility with respect to a ground color of the medium, that is, a color that is less likely to be seen, since the ejection unit ejects the liquid of the second color and the liquid of the third color onto the medium, it is possible to prevent a decrease in visibility as compared with a case of a single color. That is, since the liquid of the second color and the liquid of the third color are mixed on the medium, it is possible to prevent a decrease in the visibility as compared with a case of a single color. In addition, it is possible to prevent a specific color from decreasing first.

The recording apparatus according to an eighth aspect of the present disclosure is an aspect according to the third aspect, in which brightness of the second color is closer to brightness of a color of the medium than brightness of the first color and brightness of the third color.

Note that the present aspect may also be an aspect according to the fifth aspect or the seventh aspect.

According to the present aspect, since the brightness of the second color is closer to the brightness of the color of the medium than the brightness of the first color and the brightness of the third color, the visibility of the liquid of the second color alone with respect to the ground color of the medium is low. In this case, since the liquid of the second color and the liquid of the third color are ejected from the ejection unit onto the medium, that is, since color mixing occurs on the medium, it is possible to prevent a decrease in the visibility as compared with a case of a single color.

The recording apparatus according to a ninth aspect of the present disclosure is an aspect according to the first aspect, in which the ejection unit is configured to eject liquids of multiple colors, the control unit causes, in the second mode, the ejection unit to eject, among the liquids of multiple colors, a liquid of a second color and a liquid of another color onto the medium instead of a liquid of a first color, and brightness of the second color is closer to brightness of a color of the medium than brightness of all other colors.

According to the present aspect, since the brightness of the second color is closer to the brightness of the color of the medium than brightness of all other colors, the visibility of the liquid of the second color alone with respect to the ground color of the medium is low. The control unit is configured to cause, in the second mode, the ejection unit to eject, among the liquids of multiple colors, the liquid of the second color and a liquid of another color onto the medium instead of the liquid of the first color, that is, regardless of a remaining amount of the liquid of the first color.

Accordingly, since the liquid of the second color having low visibility is preferentially used in combination with the liquid of another color, it is possible to prevent the liquid of a color that is less likely to be seen, that is, having low visibility, from remaining at the end. Therefore, the liquid of a color having low visibility can be used up until the ejection unit enters the idle ejection state in a state where the visibility is ensured by combining the liquid of a color having low visibility with the liquid of another color.

The recording apparatus according to a tenth aspect of the present disclosure is an aspect according to the first aspect, in which the ejection unit is configured to eject liquids of multiple colors, and the control unit causes, in the second mode, the ejection unit to eject, among the liquids of multiple colors, a liquid of a second color and a liquid of another color onto the medium when the first detection unit detects that liquid amounts of the liquids of all the colors fall below the predetermined amount, and brightness of the second color is closer to brightness of a color of the medium than brightness of all other colors.

Note that the present aspect may also be an aspect according to the seventh aspect.

According to the present aspect, the ejection unit is caused, in the second mode, to eject, among the liquids of multiple colors, the liquid of the second color and the liquid of another color onto the medium when the first detection unit detects the fact indicating that the liquid amounts of the liquids of all the colors fall below the predetermined amount. That is, the ejection of the liquid of the second color and the liquid of another color until the idle ejection state is not performed until the liquid amounts of all the colors fall below the predetermined amount. Accordingly, it is possible to reduce the risk of failure occurrence of the ejection unit.

In addition, the ejection unit is caused to eject the liquid of the second color among the liquids of multiple colors and the liquid of another color onto the medium when the first detection unit detects the fact indicating that the liquid amounts of the liquids of all the colors fall below the predetermined amount. Further, the brightness of the second color is closer to the brightness of the color of the medium than the brightness of all the other colors. In other words, the liquid of the second color has the lowest visibility with respect to the ground color of the medium. However, the liquid of the second color is ejected together with the liquid of another color. Accordingly, since the liquid of the second color having low visibility is preferentially used in combination with the liquid of another color, it is possible to prevent the liquid of a color that is less likely to be seen, that is, having low visibility, from remaining at the end. Therefore, the liquid of a color having low visibility can be used up until the ejection unit enters the idle ejection state in a state where the visibility is ensured by combining the liquid of a color having low visibility with the liquid of another color.

The recording apparatus according to an eleventh aspect of the present disclosure is an aspect according to the first aspect, in which the ejection unit is configured to eject liquids of multiple colors, the control unit causes, in the second mode, the ejection unit to eject, among the liquids of multiple colors, a liquid of a second color and a liquid of a third color onto the medium instead of a liquid of a first color, and the liquid of the first color is black.

Note that the present aspect may also be an aspect according to the fifth aspect or the ninth aspect.

According to the present aspect, the control unit causes, in the second mode, the ejection unit to eject the liquid of the second color and the liquid of the third color onto the medium instead of the liquid of the first color among the liquids of multiple colors. Further, the liquid of the first color is a black liquid. That is, the control unit causes the ejection unit to eject a liquid of a mixed color of the liquid of the second color and the liquid of the third color instead of the black liquid. Accordingly, it is possible to prevent consumption of the black liquid. It is expected that many of the media used for printing in an emergency have colors other than black, particularly white. Therefore, it is possible to effectively use a black liquid having high visibility with respect to the media. A printed matter with good visibility can also be obtained without using a black liquid.

The recording apparatus according to a 12th aspect of the present disclosure is an aspect according to the first aspect, and further includes a storage unit, in which the control unit, in the second mode, stores, in the storage unit, information indicating that the ejection unit becomes unable to eject the liquid in the second mode.

Note that the present aspect may also be an aspect according to any one of the second to the eleventh aspects.

According to the present aspect, the control unit, in the second mode, is configured to store, in the storage unit, information indicating that the ejection unit becomes unable to eject the liquid. Accordingly, information indicating that the idle ejection state occurs in the second mode is stored in the storage unit, so that the information can be used for after service.

The recording apparatus according to a 13th aspect of the present disclosure is an aspect according to the first aspect, in which the supply unit includes a reservoir that stores the liquid from the liquid container, and the first detection unit detects that a liquid amount in the reservoir falls below the predetermined amount.

Note that the present aspect may also be an aspect according to any one of the second to the 12th aspects.

According to the present aspect, the supply unit includes the reservoir that stores the liquid from the liquid container. Further, the first detection unit detects the fact indicating that the liquid amount in the reservoir falls below the predetermined amount. That is, since it is detected that the liquid amount in the reservoir falls below the predetermined amount, the liquid in the liquid container such as an ink cartridge can be used up to the maximum. Meanwhile, in the first mode, the liquid between the first detection unit and the ejection unit is not ejected, whereas in the second mode, the liquid can be ejected.

The recording apparatus according to a 14th aspect of the present disclosure is an aspect according to the first aspect, in which the supply unit includes a reservoir that stores the liquid from the liquid container, the recording apparatus further includes a waste liquid collection unit configured to collect a waste liquid discharged from the ejection unit and store the waste liquid in a waste liquid container, and the control unit returns, in the second mode, the waste liquid collected by the waste liquid collection unit to the reservoir.

Note that the present aspect may also be an aspect according to any one of the second to the 13th aspects.

According to the present aspect, the control unit is configured to return, in the second mode, the waste liquid collected by the waste liquid collection unit to the reservoir in the second mode. Accordingly, since the waste liquid is returned to the reservoir, the necessity of paying attention to the capacity of the waste liquid container is reduced. Further, since an amount of the liquid such as ink used for printing can be increased, the continuity of printing can be more effectively increased.

The recording apparatus according to a 15th aspect of the present disclosure is an aspect according to the first aspect, and further includes: a waste liquid collection unit configured to collect a waste liquid discharged from the ejection unit and store the waste liquid in a waste liquid container; and a third detection unit configured to detect that a liquid amount in the waste liquid container exceeds an allowable amount, in which the control unit continues, in the second mode, the ejection of the liquid by the ejection unit even when the third detection unit detects the fact indicating that the liquid amount in the waste liquid container exceeds the allowable amount.

Note that the present aspect may also be an aspect according to any one of the second to the 14th aspects.

According to the present aspect, the control unit is configured to continue, in the second mode, the ejection of the liquid by the ejection unit even when the third detection unit detects the fact indicating that the liquid amount in the waste liquid container exceeds the allowable amount. Accordingly, even when the waste liquid container is filled up, the leaked waste liquid does not immediately flow out to the outside of the recording apparatus, and thus, in an emergency, it is possible to improve the continuity of printing by continuing printing in this state.

The recording apparatus according to a 16th aspect of the present disclosure is an aspect according to the 15th aspect, and further includes: a housing constituting an appearance of the recording apparatus; and a fourth detection unit configured to detect the waste liquid leaking to an outside of the housing, in which the control unit restricts, in the second mode, the ejection of the liquid by the ejection unit when the waste liquid is detected by the fourth detection unit.

According to the present aspect, the recording apparatus further includes the fourth detection unit that detects the waste liquid leaking to the outside of the housing, and the control unit is configured to stop, in the second mode, the ejection of the liquid by the ejection unit when the waste liquid is detected by the fourth detection unit. Accordingly, when the waste liquid leaks to the outside of the housing, that is, to the outside of the apparatus, the ejection of the liquid is stopped to stop printing, and thus it is possible to prevent failure occurrence outside the apparatus.

The recording apparatus according to 17th aspect of the present disclosure is an aspect according to the first aspect, and further includes: a waste liquid collection unit configured to collect a waste liquid discharged from the ejection unit and store the waste liquid in a waste liquid container; a third detection unit configured to detect that a liquid amount in the waste liquid container exceeds an allowable amount; and a second waste liquid container configured to store the waste liquid, in which the control unit causes , in the second mode, the second waste liquid container to store the waste liquid collected by the waste liquid collection unit when the third detection unit detects the fact indicating that the liquid amount in the waste liquid container exceeds the allowable amount.

Note that the present aspect may also be an aspect according to any one of the second to the 16th aspects.

According to the present aspect, the control unit is configured to store, in the second mode, the waste liquid collected by the waste liquid collection unit in the second waste liquid container when the third detection unit detects the fact indicating that the liquid amount in the waste liquid container exceeds the allowable amount. Accordingly, even when the waste liquid container is filled up, it is possible to continue printing by delaying the occurrence of liquid leakage to the outside of the apparatus by returning the waste liquid to the spare second waste liquid container.

The recording apparatus according to an 18th aspect of the present disclosure is an aspect according to the first aspect, and further includes a plug configured to receive power supply, in which the control unit is configured to execute the first mode when the plug is supplied with power from a commercial power supply, and execute the second mode when the plug is supplied with power from a battery.

Note that the present aspect may also be an aspect according to any one of the second to the 17th aspects.

According to the present aspect, the control unit is configured to execute the first mode when the plug is supplied with power from the commercial power supply, and execute the second mode when the plug is supplied with power from the battery. Accordingly, by executing the first mode when the general commercial power supply is used and executing the second mode when the power is supplied from the battery, it is possible to reduce the possibility that the second mode is erroneously executed at a regular state.

A control method of a recording apparatus according to a 19th aspect of the present disclosure is a control method of a recording apparatus that performs recording by ejecting a liquid onto a medium and that includes an ejection unit configured to eject the liquid onto the medium, a supply unit configured to supply the liquid from a liquid container to the ejection unit, and a first detection unit configured to detect that an amount of the liquid inside the liquid container or inside the supply unit falls below a predetermined amount. The control method includes: executing a first mode in which ejection of the liquid onto the medium by the ejection unit is restricted when the first detection unit detects the fact indicating that the amount of the liquid falls below the predetermined amount; and executing a second mode in which the ejection of the liquid onto the medium by the ejection unit is not restricted until the ejection unit becomes unable to eject the liquid.

According to the present aspect, the same effects as the effects according to the first aspect can be obtained.

### Embodiments

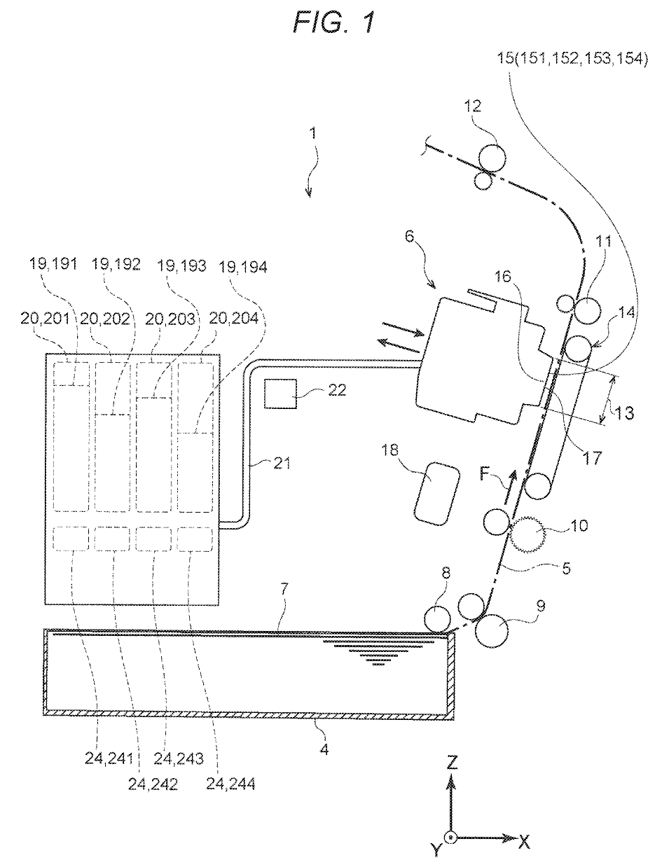

Hereinafter, a recording apparatus according to an embodiment of the present disclosure will be specifically described with reference to FIGS. 1 to 6.

In the description below, three axes orthogonal to one another are respectively defined as an X axis, a Y axis, and a Z axis as illustrated in the drawings. Directions indicated by arrows of the three axes (X, Y, and Z) are positive (+) directions of the respective directions, and opposite directions thereof are negative (-) directions. A Z-axis direction corresponds to a vertical direction, that is, a direction in which the gravity acts, a +Z direction represents a vertically upward direction and a -Z direction represents a vertically downward direction. An X-axis direction and a Y-axis direction are equivalent to a horizontal direction. A +Y direction indicates a front direction of the recording apparatus and a -Y direction indicates a rear direction of the recording apparatus. The +X direction indicates a right direction of the recording apparatus, and the -X direction indicates a left direction of the recording apparatus.

### Overall Schematic Description of Recording Apparatus

A recording apparatus 1 according to the present embodiment is, for example, an inkjet printer that performs recording by ejecting ink, which is a liquid, onto a medium 7 such as paper.

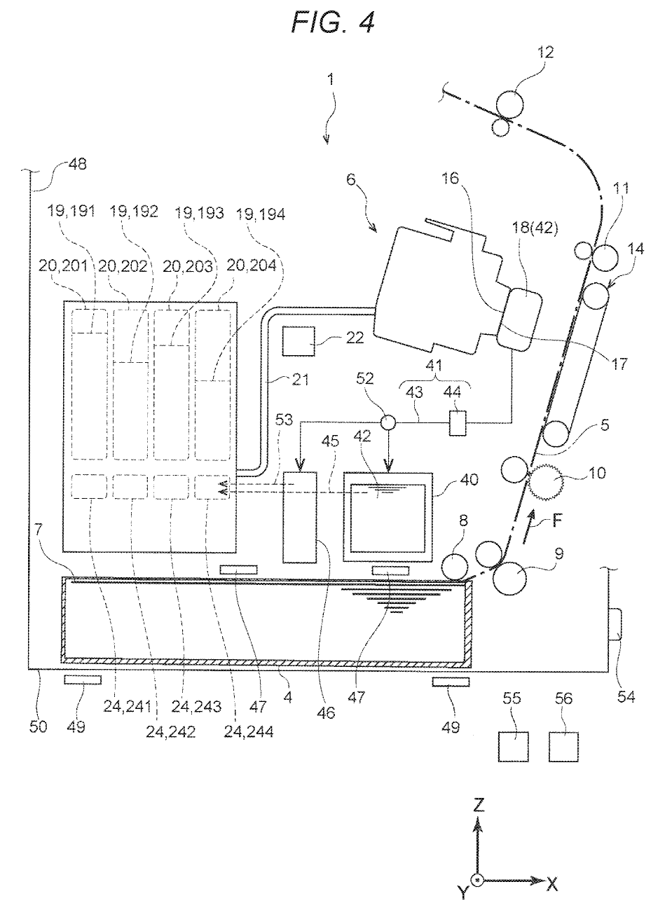

As illustrated in FIGS. 1 and 4, the recording apparatus 1 includes a medium accommodation unit 4, a conveyance path 5, and an ejection unit 6. The medium 7 is accommodated in the medium accommodation unit 4. The medium 7 is picked up from the inside of the medium accommodation unit 4 by a pick roller 8 and sent out to the conveyance path 5.

Conveyance rollers 9, 10, 11, and 12 that apply a conveyance force to the medium 7 are disposed on the conveyance path 5. Recording is executed on the medium 7 conveyed on the conveyance path 5 in a recording execution region 13 of the ejection unit 6. A belt unit 14 is disposed in the recording execution region 13.

In the present embodiment, the ejection unit 6 includes a head 16 capable of ejecting ink, which is a liquid 19, as droplets from a nozzle 15 toward the medium 7, and a cap 18 that covers a nozzle surface 17 of the head 16. Here, a line head that is long in a width direction (Y-axis direction) is used as the head 16. The head 16 can be displaced between a recording execution position (position in FIG. 1) where recording is executed by ejecting the liquid 19 onto the medium 7 and a maintenance position (position in FIG. 4) where the nozzle surface 17 is covered with the cap 18. The cap 18 can also be displaced between the maintenance position (position in FIG. 4) and the recording execution position (position in FIG. 1).

### Embodiment 1

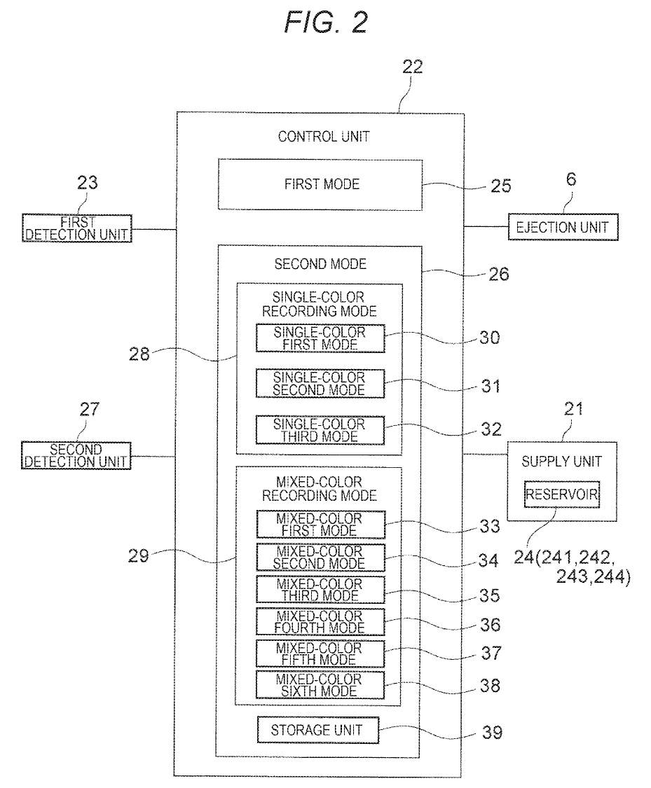

First, a configuration of the recording apparatus 1 according to Embodiment 1 will be described with reference to FIGS. 1 and 2.

The recording apparatus 1 according to the present embodiment includes the ejection unit 6 that ejects the liquid 19 onto the medium 7, a supply unit 21 that supplies the liquid 19 from a liquid container 20 to the ejection unit 6, and a control unit 22 that controls the ejection unit 6. Further, the recording apparatus 1 includes a first detection unit 23 (FIG. 2) that detects that an amount of the liquid 19 inside the liquid container 20 or the supply unit 21 falls below a predetermined amount Pa.

When an amount of the liquid 19 decreases to such an extent that the ejection unit 6 cannot eject the liquid 19, in other words, when an idle ejection state occurs, the risk of failure of the ejection unit 6 increases, so that the predetermined amount Pa is a remaining amount of the liquid 19 that is set in advance so as not to bring the ejection unit 6 into the idle ejection state.

In the present embodiment, the detection of the fact indicating that the amount of the liquid 19 falls below the predetermined amount Pa by the first detection unit 23 is configured such that a remaining amount in a reservoir 24 (FIG. 1) that stores the liquid 19 of the liquid container 20 is directly detected. The reservoir 24 is coupled to the supply unit 21. The detection of the fact indicating that the amount of the liquid 19 falls below the predetermined amount Pa by the first detection unit 23 may be performed by directly detecting a remaining amount in the liquid container 20 or the supply unit 21, or may be performed by counting the number of times of ejection of liquid droplets from each nozzle 15 and performing calculation based on a count value.

As illustrated in FIG. 2, the control unit 22 has a first mode 25 and a second mode 26, and can individually execute the modes 25 and 26. In the first mode 25, when the first detection unit 23 detects the fact indicating that the amount of the liquid 19 falls below the predetermined amount Pa, the ejection of the liquid 19 onto the medium 7 by the ejection unit 6 is restricted. In the second mode 26, the ejection of the liquid 19 onto the medium 7 by the ejection unit 6 is not restricted until the ejection unit 6 cannot eject the liquid 19.

"Restricted" in "the ejection of the liquid 19 onto the medium 7 by the ejection unit 6 is restricted" refers to notifying a user that the liquid 19 needs to be replenished, and when the liquid 19 is not replenished thereafter, the liquid 19 is not allowed to be ejected.

The first mode 25 is a control mode used for a regular recording operation that is not an emergency. In the case of an inkjet printer, the "regular recording operation" is an operation associated with regular recording execution in a regular state that is not an emergency such as a disaster.

Specifically, in the case of the head 16, as illustrated in FIG. 1, recording is executed by ejecting ink onto the medium 7 based on recording data, and when the head 16 is not used, as illustrated in FIG. 4, the nozzle surface 17 is covered with the cap 18 to prevent drying of the ink, flushing, cleaning of the nozzle 15, and the like are performed.

When the amount of the liquid 19 falls below the predetermined amount Pa, the restriction is imposed.

The second mode 26 is a control mode used for a recording operation in an emergency such as a disaster. The control unit 22 can execute the second mode 26 when receiving information indicating an emergency. The information indicating an emergency may be received from a user input, public information such as an earthquake early warning or evacuation information may be received, or determination may be made based on a detection result of a sensor or the like.

In the second mode 26, a second detection unit 27 detects that the ejection unit 6 cannot eject the liquid 19. Here, a unit that directly detects the presence or absence of a droplet ejected from the nozzle 15 by a sensor (not illustrated) is used as the second detection unit 27.

The second detection unit 27 may determine the idle ejection state by determining an ink ejection state based on features of a signal of a piezoelectric element immediately after ink is ejected, as described in paragraphs 0036 and 0063 in JP-A-2017-24273.

The control unit 22 includes a CPU, a flash ROM, and a RAM. The CPU executes various kinds of calculating processing according to programs stored in the flash ROM and controls an overall operation of the recording apparatus 1. The flash ROM, which is an example of a storage unit, is a readable and writable nonvolatile memory. The RAM, which is an example of a storage, temporarily stores various kinds of information.

In the present embodiment, the control unit 22 executes an operation such as a conveyance operation by the conveyance rollers 9, 10, 11, and 12 and the belt unit 14, and ejection of liquid droplets onto the medium 7 by the ejection unit 6, that is, a recording execution operation.

In the present embodiment, the ejection unit 6 can eject the liquid 19 of multiple colors.

As illustrated in FIG. 1, four liquid containers 20 of a first liquid container 201, a second liquid container 202, a third liquid container 203, and a fourth liquid container 204 are provided. The first liquid container 201 contains a liquid 191 of a first color. The second liquid container 202 contains a liquid 192 of a second color. The third liquid container 203 contains a liquid 193 of a third color. The fourth liquid container 204 contains a liquid 194 of a fourth color.

Here, the liquid 191 of the first color is a black liquid. The liquid 192 of the second color is a yellow liquid. The liquid 193 of the third color is a magenta liquid, that is, a red liquid. The liquid 194 of the fourth color is a cyan liquid, that is, a blue liquid.

The above is merely one example, and the liquid 191 of the first color may be any one liquid of the other three colors instead of the black liquid. The same applies to the liquid 192 of the second color, the liquid 193 of the third color, and the liquid 194 of the fourth color. Multiple colors are not limited to the four colors described above, and may be colors other than black, yellow, red, and blue.

The liquids of the four colors including the liquid 191 of the first color, the liquid 192 of the second color, the liquid 193 of the third color, and the liquid 194 of the fourth color are individually supplied to the ejection unit 6 by the supply unit 21 from the liquid containers 201, 202, 203 and 204 via the reservoir 24, that is, a first reservoir 241, a second reservoir 242, a third reservoir 243, and a fourth reservoir 244. The supply unit 21 may include a pump (not illustrated) serving as a liquid feeding unit, and the liquids 191, 192, 193 and 194 may be fed to the ejection unit 6 by the pump.

The ejection unit 6 individually includes a first nozzle 151 that ejects the liquid 191 of the first color, a second nozzle 152 that ejects the liquid 192 of the second color, a third nozzle 153 that ejects the liquid 193 of the third color, and a fourth nozzle 154 that ejects the liquid 194 of the fourth color.

As illustrated in FIG. 2, in the present embodiment, the second mode 26 has a single-color recording mode 28 and a mixed-color recording mode 29.

The single-color recording mode 28 includes a single-color first mode 30, a single-color second mode 31, and a single-color third mode 32. The mixed-color recording mode 29 includes a mixed-color first mode 33, a mixed-color second mode 34, a mixed-color third mode 35, a mixed-color fourth mode 36, a mixed-color fifth mode 37, and a mixed-color sixth mode 38.

Each of the modes 30, 31, 32, 33, 34, 35, 36, 37 and 38 is configured to be executed when a user selects one of the modes from an operation panel (not illustrated) or the like. In the present embodiment, the single-color first mode 30 is set to be executed by default. Alternatively, a specific mode may be automatically executed, or the specific mode may be automatically selected based on a specific condition.

Each of the modes 30, 31, 32, 33, 34, 35, 36, 37 and 38 will be described below.

### Single-Color First Mode

The single-color first mode 30 is configured to cause the ejection unit 6 to eject the liquid 192 of the second color onto the medium 7 instead of the liquid 191 of the first color when the ejection unit 6 cannot eject the liquid 191 of the first color among the liquids 191, 192, 193 and 194 of multiple colors. That is, the following control is executed.

(1) When the control unit 22 receives information indicating an emergency, the single-color first mode 30 is set.

(2) Subsequently, when recording data is received, recording is executed by ejecting the liquid 191 of the first color, which is one of the liquids of the four colors, from the ejection unit 6.

(3) When the second detection unit 27 detects that the ejection unit 6 enters the idle ejection state for the liquid 191 of the first color, the ejection unit 6 is caused to eject the liquid 192 of the second color, which is another one of the liquids of the four colors, instead of the liquid 191 of the first color.

(4) When the second detection unit 27 detects that the ejection unit 6 enters the idle ejection state for the liquid 192 of the second color, the ejection unit 6 is caused to eject the liquid 193 of the third color, which is another one of the liquids of the four colors, instead of the liquid 192 of the second color.

(5) When the second detection unit 27 detects that the ejection unit 6 enters the idle ejection state for the liquid 193 of the third color, the ejection unit 6 is caused to eject the remaining one liquid 194 of the fourth color, which is the remaining one of the liquids of the four colors, instead of the liquid 193 of the third color.

(6) When the ejection unit 6 enters the idle ejection state for the liquid 194 of the fourth color, the liquid 19 cannot be ejected, and a recording operation ends.

### Single-Color Second Mode

The single-color second mode 31 is configured to cause the ejection unit 6 to eject the liquid 192 of the second color onto the medium 7 instead of the liquid 191 of the first color when the first detection unit 23 detects that an amount of the liquid 191 of the first color among the liquids 191, 192, 193 and 194 of multiple colors falls below the predetermined amount Pa. That is, the following control is executed.

(1) When the control unit 22 receives information indicating an emergency, the single-color second mode 31 is set.

(2) Subsequently, when recording data is received, recording is executed by ejecting the liquid 191 of the first color, which is one of the liquids of the four colors, from the ejection unit 6.

(3) Subsequently, when the first detection unit 23 detects that an amount of the liquid 191 of the first color falls below the predetermined amount Pa, the ejection unit 6 is caused to eject the liquid 192 of the second color, which is another one of the liquids of the four colors, instead of the liquid 191 of the first color in a state where there is the predetermined amount Pa of residual liquid.

(4) When the second detection unit 27 detects that the ejection unit 6 enters the idle ejection state for the liquid 192 of the second color, the ejection unit 6 is caused to eject the liquid 193 of the third color, which is another one of the liquids of the four colors, instead of the liquid 192 of the second color.

(5) When the second detection unit 27 detects that the ejection unit 6 enters the idle ejection state for the liquid 193 of the third color, the ejection unit 6 is caused to eject the liquid 194 of the fourth color, which is another one of the liquids of the four colors, instead of the liquid 193 of the third color.

(6) When the second detection unit 27 detects that the ejection unit 6 enters the idle ejection state for the liquid 194 of the fourth color, the ejection unit 6 is caused to eject the liquid 191 of the first color instead of the liquid 194 of the fourth color.

(7) When the ejection unit 6 enters the idle ejection state for the liquid 191 of the first color, the liquid 19 cannot be ejected, and a recording operation ends.

### Single-Color Third Mode

The single-color third mode 32 is configured to cause the ejection unit 6 to eject the liquid 192 of the second color onto the medium 7 instead of the liquid 191 of the first color when the first detection unit 23 detects that liquid amounts of the liquids 191, 192, 193 and 194 of all colors fall below the predetermined amount Pa and the ejection unit 6 cannot eject the liquid 191 of the first color. That is, the following control is executed.

(1) When the control unit 22 receives information indicating an emergency, the single-color third mode 32 is set.

(2) Subsequently, when recording data is received, recording is executed by causing the ejection unit 6 to sequentially eject the liquids of the four colors one by one. That is, the ejection unit 6 is caused to eject only the liquid 19 of one of the four colors, and when the first detection unit 23 detects that a liquid amount falls below the predetermined amount Pa, the ejection unit 6 is caused to eject only the liquid 19 of another one of the four colors.

(3) When the first detection unit 23 detects that the liquid amounts of the liquids of all the colors sequentially fall below the predetermined amount Pa one by one, the ejection unit 6 is caused to eject only the liquid 191 of the first color among the liquids of the four colors.

(4) Subsequently, when the second detection unit 27 detects that the ejection unit 6 enters the idle ejection state for the liquid 191 of the first color, the ejection unit 6 is caused to eject the liquid 192 of the second color, which is another one of the liquids of the four colors, instead of the liquid 191 of the first color.

(5) Subsequently, when the second detection unit 27 detects that the ejection unit 6 enters the idle ejection state for the liquid 192 of the second color, the ejection unit 6 is caused to eject the liquid 193 of the third color, which is another one of the liquids of the four colors, instead of the liquid 192 of the second color.

(6) Subsequently, when the second detection unit 27 detects that the ejection unit 6 enters the idle ejection state for the liquid 193 of the third color, the ejection unit 6 is caused to eject the liquid 194 of the fourth color, which is another one of the liquids of the four colors, instead of the liquid 193 of the third color.

(7) When the ejection unit 6 enters the idle ejection state for the liquid 194 of the fourth color, the liquid 19 cannot be ejected, and a recording operation ends.

### Mixed-Color First Mode

The mixed-color first mode 33 is configured to cause the ejection unit 6 to eject the liquid 192 of the second color and the liquid 193 of the third color onto the medium 7 instead of the liquid 191 of the first color when the ejection unit 6 cannot eject the liquid 191 of the first color among the liquids 191, 192, 193 and 194 of multiple colors. That is, the following control is executed.

(1) When the control unit 22 receives information indicating an emergency, the mixed-color first mode 33 is set.

(2) Subsequently, when recording data is received, recording is executed by ejecting the liquid 191 of the first color, which is one of the liquids of the four colors, from the ejection unit 6.

(3) When the second detection unit 27 detects that the ejection unit 6 enters the idle ejection state for the liquid 191 of the first color, the ejection unit 6 is caused to eject the liquid 192 of the second color and the liquid 193 of the third color instead of the liquid 191 of the first color. Recording is executed on the medium 7 using a mixed-color of two colors.

(4) When the second detection unit 27 detects that the ejection unit 6 enters the idle ejection state for the liquid 192 of the second color and the liquid 193 of the third color, the ejection unit 6 is caused to eject the liquid 194 of the fourth color instead of the liquids 192 and 193 of the two colors.

(5) When the ejection unit 6 enters the idle ejection state for the liquid 194 of the fourth color, the liquid 19 cannot be ejected, and a recording operation ends.

When brightness of a color of the medium 7 and brightness of a color of the liquid 19 are close to each other, visibility of a recording result tends to be low.

In this case, as compared with a case of using a liquid of a single color, it is possible to improve the visibility by using a liquid of a mixed-color obtained by combining a liquid of one color with a liquid of another color instead of using a liquid of a single color which tends to cause low visibility.

In the present embodiment, a color of a liquid to be mixed is determined according to a color of the medium 7. That is, according to the color of the medium 7, a user can set a combination of colors to be mixed from an operation panel (not illustrated) or the like.

Specifically, in (3) of the mixed-color first mode 33, brightness of the second color is set to be closer to brightness of the color of the medium 7 than brightness of the first color and brightness of the third color.

### Mixed-Color Second Mode

The mixed-color second mode 34 is configured to cause the ejection unit 6 to eject the liquid 192 of the second color and the liquid 193 of the third color onto the medium 7 instead of the liquid 191 of the first color when the first detection unit 23 detects that an amount of the liquid 191 of the first color among the liquids 191, 192, 193 and 194 of multiple colors falls below the predetermined amount Pa. That is, the following control is executed.

(1) When the control unit 22 receives information indicating an emergency, the mixed-color second mode 34 is set.

(2) Subsequently, when recording data is received, recording is executed by ejecting the liquid 191 of the first color, which is one of the liquids of the four colors, from the ejection unit 6.

(3) Subsequently, when the first detection unit 23 detects that an amount of the liquid 191 of the first color falls below the predetermined amount Pa, the ejection unit 6 is caused to eject the liquid 192 of the second color and the liquid 193 of the third color instead of the liquid 191 of the first color in a state where there is the predetermined amount Pa of residual liquid. Recording is executed on the medium 7 using a mixed-color of two colors.

(4) When the second detection unit 27 detects that the ejection unit 6 enters the idle ejection state for the liquid 192 of the second color and the liquid 193 of the third color, the ejection unit 6 is caused to eject the liquid 194 of the fourth color instead of the liquids 192 and 193 of the two colors.

(5) When the second detection unit 27 detects that the ejection unit 6 enters the idle ejection state for the liquid 194 of the fourth color, the ejection unit 6 is caused to eject the liquid 191 of the first color instead of the liquid 194 of the fourth color.

(6) When the ejection unit 6 enters the idle ejection state for the liquid 191 of the first color, the liquid 19 cannot be ejected, and a recording operation ends.

### Mixed-Color Third Mode

The mixed-color third mode 35 is configured to cause the ejection unit 6 to eject the liquid 192 of the second color and the liquid 193 of the third color onto the medium 7 instead of the liquid 191 of the first color when the first detection unit 23 detects that liquid amounts of the liquids 191, 192, 193 and 194 of all colors fall below the predetermined amount Pa and the ejection unit 6 cannot eject the liquid 191 of the first color. That is, the following control is executed.

(1) When the control unit 22 receives information indicating an emergency, the mixed-color third mode 35 is set.

(2) Subsequently, when recording data is received, recording is executed by causing the ejection unit 6 to sequentially eject the liquids of the four colors one by one.

(3) When the first detection unit 23 detects that the liquid amounts of the liquids of all the colors sequentially fall below the predetermined amount Pa one by one, the ejection unit 6 is caused to eject only the liquid 191 of the first color among the liquids of the four colors.

(4) Subsequently, when the second detection unit 27 detects that the ejection unit 6 enters the idle ejection state for the liquid 191 of the first color, the ejection unit 6 is caused to eject the liquid 192 of the second color and the liquid 193 of the third color instead of the liquid 191 of the first color. Recording is executed on the medium 7 using a mixed-color of two colors.

(5) Subsequently, when the second detection unit 27 detects that the ejection unit 6 enters the idle ejection state for the liquid 192 of the second color and the liquid 193 of the third color, the ejection unit 6 is caused to eject the liquid 194 of the fourth color instead of the liquids 192 and 193 of the two colors.

(6) When the second detection unit 27 detects that the ejection unit 6 enters the idle ejection state for the liquid 194 of the fourth color, the liquid 19 cannot be ejected, and a recording operation ends.

### Mixed-Color Fourth Mode

The mixed-color fourth mode 36 is configured to cause the ejection unit 6 to eject the liquid 192 of the second color and a liquid of another color onto the medium 7 instead of the liquid 191 of the first color among the liquids 191, 192, 193 and 194 of multiple colors, that is, regardless of a remaining amount of the liquid 191 of the first color, when brightness of the second color is closer to brightness of a color of the medium 7 than brightness of the first color and brightness of the third color. That is, the following control is executed.

(1) When the control unit 22 receives information indicating an emergency, the mixed-color fourth mode 36 is set.

(2) Subsequently, when recording data is received, even if the liquid 191 of the first color is set to be ejected from the ejection unit 6, the liquid 192 of the second color and the liquid 193 of the third color are ejected from the ejection unit 6 instead of the liquid 191 of the first color.

That is, since the liquid 193 of the third color is mixed with the liquid 192 of the second color and is ejected onto the medium 7, recording is executed in a state where visibility is higher than single color recording with the liquid 192 of the second color.

Here, the third liquid 193 is used as "another liquid", but the liquid 194 of the fourth color may be used instead. The liquid 193 of the third color and the liquid 194 of the fourth color may be alternately used.

(3) When the second detection unit 27 detects that the ejection unit 6 enters the idle ejection state for the liquid 192 of the second color and the liquid 193 of the third color, the ejection unit 6 is caused to eject the liquid 194 of the fourth color instead of the liquids 192 and 193 of the two colors.

(4) When the second detection unit 27 detects that the ejection unit 6 enters the idle ejection state for the liquid 194 of the fourth color, the ejection unit 6 is caused to eject the liquid 191 of the first color instead of the liquid 194 of the fourth color.

(5) When the ejection unit 6 enters the idle ejection state for the liquid 191 of the first color, the liquid 19 cannot be ejected, and a recording operation ends.

### Mixed-Color Fifth Mode

The mixed-color fifth mode 37 is configured to cause the ejection unit 6 to eject the liquid 192 of the second color and a liquid of another color onto the medium 7 when the first detection unit 23 detects that the liquid amounts of the liquids 191, 192, 193 and 194 of all the colors fall below the predetermined amount Pa in a case where the brightness of the second color is closer to the brightness of the color of the medium 7 than brightness of the other colors. That is, the following control is executed.

(1) When the control unit 22 receives information indicating an emergency, the mixed-color fifth mode 37 is set.

(2) Subsequently, when recording data is received, recording is executed by causing the ejection unit 6 to sequentially eject the liquids of the four colors one by one.

(3) When the first detection unit 23 detects that the liquid amounts of the liquids of all the colors sequentially fall below the predetermined amount Pa one by one, the ejection unit 6 is caused to eject the liquid 192 of the second color and the liquid 193 of the third color. Recording is executed on the medium 7 using a mixed-color of two colors.

That is, since the liquid 193 of the third color is mixed with the liquid 192 of the second color and is ejected onto the medium 7, recording is executed in a state where visibility is higher than single color recording with the liquid 192 of the second color.

Here, the third liquid 193 is used as "another liquid", but the liquid 194 of the fourth color may be used instead. The liquid 193 of the third color and the liquid 194 of the fourth color may be alternately used.

(4) When the second detection unit 27 detects that the ejection unit 6 enters the idle ejection state for the liquid 192 of the second color and the liquid 193 of the third color, the ejection unit 6 is caused to eject the liquid 194 of the fourth color instead of the liquids 192 and 193 of the two colors.

(5) When the second detection unit 27 detects that the ejection unit 6 enters the idle ejection state for the liquid 194 of the fourth color, the ejection unit 6 is caused to eject the liquid 191 of the first color instead of the liquid 194 of the fourth color.

(6) When the ejection unit 6 enters the idle ejection state for the liquid 191 of the first color, the liquid 19 cannot be ejected, and a recording operation ends.

### Mixed-Color Sixth Mode

In the mixed-color sixth mode 38, when the first color is black, the ejection unit 6 is configured to eject the liquid 192 of the second color and the liquid 193 of the third color onto the medium instead of the liquid 191 of the first color among the liquids 191, 192, 193 and 194 of multiple colors. That is, the following control is executed.

(1) When the control unit 22 receives information indicating an emergency, the mixed-color sixth mode 38 is set.

(2) Subsequently, when recording data is received, even if the liquid 191 of the first color is set to be ejected from the ejection unit 6, the liquid 192 of the second color and the liquid 193 of the third color are ejected from the ejection unit 6 instead of the liquid 191 of the first color.

(3) When the second detection unit 27 detects that the ejection unit 6 enters the idle ejection state for the liquid 192 of the second color and the liquid 193 of the third color, the ejection unit 6 is caused to eject the liquid 194 of the fourth color instead of the liquids 192 and 193 of the two colors.

(4) When the second detection unit 27 detects that the ejection unit 6 enters the idle ejection state for the liquid 194 of the fourth color, the ejection unit 6 is caused to eject the liquid 191 of the first color instead of the liquid 194 of the fourth color.

(5) When the ejection unit 6 enters the idle ejection state for the liquid 191 of the first color, the liquid 19 cannot be ejected, and a recording operation ends.

As illustrated in FIG. 2, in the present embodiment, a storage unit 39 is provided, and the control unit 22 is configured to store, in the storage unit 39, information indicating that the ejection unit 6 cannot eject the liquids 191, 192, 193 and 194 in the second mode 26.

As illustrated in FIG. 1, in the present embodiment, although a part of the description will be repeated, the supply unit 21 includes the first reservoir 241, the second reservoir 242, the third reservoir 243, and the fourth reservoir 244 that store the liquids 191, 192, 193 and 194 from the respective liquid containers 201, 202, 203 and 204. Further, the first detection unit 23 is configured to detect that a liquid amount in each of the reservoirs 241, 242, 243 and 244 falls below the predetermined amount Pa.

### Description of Control Flow according to Embodiment 1

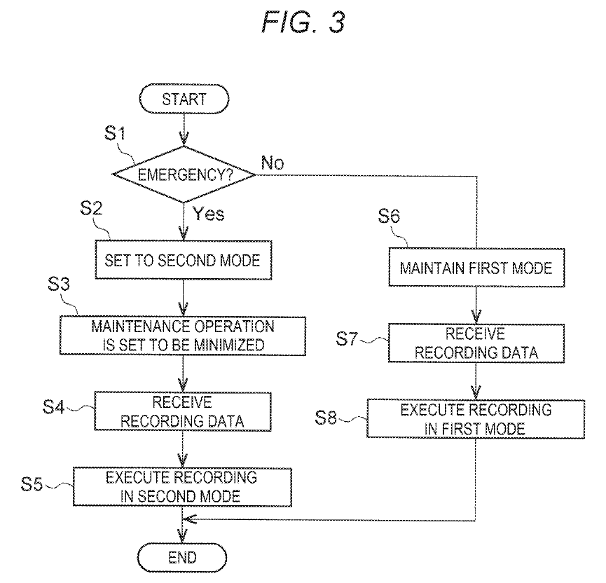

A control flow according to Embodiment 1 will be described with reference to FIG. 3.

First, in step S1, when the control unit 22 does not receive information indicating an emergency (No), the control unit 22 proceeds the control flow to step S6 and maintains the first mode 25. In step S7, when recording data for printing is received, the control flow proceeds to step S8, and recording is executed in the first mode 25.

In the first mode, when the first detection unit 23 detects that an amount of the liquid 19 falls below the predetermined amount Pa, the ejection of the liquid 19 onto the medium 7 by the ejection unit 6 is restricted. That is, control for reducing a risk of failure occurrence due to the ejection unit 6 entering the idle ejection state is executed. In a case where the first detection unit 23 detects that the amount of the liquid 19 falls below the predetermined amount Pa, a user is notified that the liquid 19 needs to be replenished, and when the liquid 19 is not replenished thereafter, the ejection unit 6 becomes unable to eject the liquid 19 before entering the idle ejection state.

On the other hand, when the information indicating an emergency is received in step S1 (Yes), the control flow proceeds to step S2, and the second mode 26 is set. That is, the mode is switched from the regular first control mode 25 to the second control mode 26, and an emergency control flow is executed in the second control mode 26.

Subsequently, the control flow proceeds to step S3, and a maintenance operation is set to be minimized. Specifically, a maintenance operation such as flushing and nozzle cleaning is reduced or is not performed. When the first detection unit 23 detects that the liquid amount falls below the predetermined amount Pa, the control unit 22 sets a state where the ejection is not restricted in the first mode 25. That is, the control unit 22 sets a state where the ink is used up while preventing a consumption amount of the ink.

Subsequently, the control flow proceeds to step S4, and when recording data for printing is received, the control flow proceeds to step S5, and recording is executed in the second mode 26. Specifically, one of the nine control modes 30, 31, 32, 33, 34, 35, 36, 37 and 38 of the second mode 26 illustrated in FIG. 2 is executed. That is, the recording is executed in a state where the continuity of printing in which ink is used up is prioritized over the reduction of the risk of failure occurrence of the ejection unit 6.

### Description of Effects of Embodiment 1

(1) In the present embodiment, the control unit 22 can execute the first mode 25 in a regular state. In the first mode 25, when the first detection unit 23 detects that the amount of the liquid 19 falls below the predetermined amount Pa, the ejection of the liquid 19 onto the medium 7 by the ejection unit 6 is restricted. In a regular state, by restricting the ejection of the liquid 19 when the amount of the liquid 19 falls below the predetermined amount Pa, it is possible to reduce the risk of failure occurrence of the ejection unit 6.

On the other hand, the control unit 22 can execute the second mode 26 in an emergency. In the second mode 26, the ejection of the liquid 19 onto the medium 7 by the ejection unit 6 is not restricted until the ejection unit 6 cannot eject the liquid 19. That is, when it is desired to continue recording, that is, printing even if the risk of failure occurrence of the ejection unit 6 is allowed, such as in an emergency, the mode is a mode in which it is possible to continue printing until the ejection unit 6 enters the idle ejection state. Accordingly, the continuity of printing can be increased by setting the second mode 26 in an emergency or the like.

(2) In the present embodiment, the control unit 22 can execute the single-color first mode 30 in the second mode 26.

The single-color first mode 30 is configured to cause the ejection unit 6 to eject the liquid 192 of the second color onto the medium 7 instead of the liquid 191 of the first color when the ejection unit 6 cannot eject the liquid 191 of the first color among the liquids 191, 192, 193 and 194 of multiple colors.

That is, when the ejection unit 6 cannot eject the liquid 191 of the first color among the liquids 191, 192, 193 and 194 of multiple colors, the ejection unit 6 continues to eject the liquid 192 of the second color until the ejection unit 6 enters the idle ejection state. Then, when the ejection unit 6 enters the idle ejection state for the liquid 192 of the second color, the ejection unit 6 continues to eject the liquid 193 of the third color until the ejection unit 6 enters the idle ejection state. Finally, the ejection unit 6 continues to eject the liquid 194 of the fourth color until the ejection unit 6 enters the idle ejection state.

In other words, the liquids 191, 192, 193 and 194 of multiple colors are configured to be used up until the ejection unit 6 enters the idle ejection state for the liquids of multiple colors one by one. Accordingly, since all of the liquids 191, 192, 193 and 194 of multiple colors are used up until the idle ejection state, it is possible to improve the continuity of printing in an emergency or the like.

(3) In the present embodiment, the control unit 22 can execute the single-color second mode 31 in the second mode 26.

The single-color second mode 31 is configured to cause the ejection unit 6 to eject the liquid 192 of the second color onto the medium 7 instead of the liquid 191 of the first color when the first detection unit 23 detects that an amount of the liquid 191 of the first color among the liquids 191, 192, 193 and 194 of multiple colors falls below the predetermined amount Pa. Then, when the ejection unit 6 enters the idle ejection state for the liquid 192 of the second color, the ejection unit 6 is caused to eject the liquid 193 of the third color until the ejection unit 6 enters the idle ejection state. Subsequently, the liquid 194 of the fourth color is ejected until the ejection unit 6 enters the idle ejection state, and finally, the ejection unit 6 continues to eject the liquid 191 of the first color until the ejection unit 6 enters the idle ejection state. Accordingly, since all of the liquids 191, 192, 193 and 194 of multiple colors are used up until the idle ejection state, it is possible to improve the continuity of printing in an emergency or the like.

Since the ejection unit 6 is caused to eject the liquid 192 of the second color onto the medium 7 in a state where the liquid 191 of the first color remains, it is possible to reduce a risk of failure occurrence of the ejection unit 6 as compared with a case where the liquid 191 of the first color is used up until the ejection unit 6 enters the idle ejection state and then the liquid 192 of the second color is ejected instead.

(4) Further, in the present embodiment, the control unit 22 can execute the single-color third mode 32 in the second mode 26.

In the single-color third mode 32, when the first detection unit 23 detects that the liquid amounts of the liquids 191, 192, 193 and 194 of all colors fall below the predetermined amount Pa, the liquid 191 of the first color is ejected until the ejection unit 6 cannot eject the liquid 191. That is, the ejection of the liquid 191 of the first color until the idle ejection state is not performed until the liquid amounts of the liquids 191, 192, 193 and 194 of all colors fall below the predetermined amount Pa. Accordingly, it is possible to reduce the risk of failure occurrence of the ejection unit 6.

When the ejection unit 6 cannot eject the liquid 191 of the first color, the liquid 192 of the second color is ejected until the idle ejection state, and subsequently, when the ejection unit 6 enters the idle ejection state for the liquid 192 of the second color, the liquid 193 of the third color is ejected from the ejection unit 6 until the idle ejection state, and finally, the liquid 194 of the fourth color is ejected until the idle ejection state. Accordingly, since all of the liquids 191, 192, 193 and 194 of multiple colors are used up until the idle ejection state, it is possible to improve the continuity of printing in an emergency or the like.

(5) In the present embodiment, the control unit 22 can execute the mixed-color first mode 33 in the second mode 26.

The mixed-color first mode 33 is configured to cause the ejection unit 6 to eject the liquid 192 of the second color and the liquid 193 of the third color onto the medium 7 instead of the liquid 191 of the first color when the ejection unit 6 cannot eject the liquid 191 of the first color among the liquids 191, 192, 193 and 194 of multiple colors. Then, when the ejection unit 6 enters the idle ejection state for the liquid 192 of the second color and the liquid 193 of the third color, the ejection unit 6 continues to eject the liquid of the fourth color until the idle ejection state. Accordingly, since all of the liquids 191, 192, 193 and 194 of multiple colors are used up until the idle ejection state, it is possible to improve the continuity of printing in an emergency or the like.

In addition, even when the liquid 192 of the second color alone is a color having low visibility with respect to the ground color of the medium 7, that is, a color that is less likely to be seen, since the ejection unit 6 ejects the liquid 192 of the second color and the liquid 193 of the third color onto the medium 7, it is possible to prevent a decrease in visibility as compared with a case of a single color. That is, since the liquid 192 of the second color and the liquid 193 of the third color are mixed on the medium 7, it is possible to prevent a decrease in the visibility as compared with a case of a single color. In addition, it is possible to prevent a specific color from decreasing first.

(6) When the brightness of the second color is closer to the brightness of the color of the medium 7 than the brightness of the first color and the brightness of the third color, the visibility of the liquid 192 of the second color alone with respect to the ground color of the medium 7 is low. In this case, in the present embodiment, since the liquid 192 of the second color and the liquid 193 of the third color are ejected from the ejection unit 6 onto the medium 7, that is, since colors are mixed on the medium 7, it is possible to prevent a decrease in the visibility as compared with a case of a single color.

(7) In the present embodiment, the control unit 22 can execute the mixed-color second mode 34 in the second mode 26.

The mixed-color second mode 34 is configured to cause the ejection unit 6 to eject the liquid 192 of the second color and the liquid 193 of the third color onto the medium 7 instead of the liquid 191 of the first color when the first detection unit 23 detects that an amount of the liquid 191 of the first color among the liquids 191, 192, 193 and 194 of multiple colors falls below the predetermined amount Pa. Then, when the ejection unit 6 enters the idle ejection state for the liquid 192 of the second color and the liquid 193 of the third color, the ejection unit 6 is caused to eject the liquid 194 of the fourth color until the ejection unit 6 enters the idle ejection state. Finally, the liquid 191 of the first color is ejected until the idle ejection state. Accordingly, since all of the liquids 191, 192, 193 and 194 of multiple colors are used up until the idle ejection state, it is possible to improve the continuity of printing in an emergency or the like.

Since the ejection unit 6 is caused to eject the liquid 192 of the second color and the liquid 193 of the third color onto the medium 7 in a state where the liquid 191 of the first color remains, it is possible to reduce a risk of failure occurrence of the ejection unit 6 as compared with a case where the liquid 191 of the first color is used up until the ejection unit 6 enters the idle ejection state and then the liquid 192 of the second color and the liquid 193 of the third color are ejected instead.

In addition, even when the liquid 192 of the second color alone is a color having low visibility with respect to the ground color of the medium 7, that is, a color that is less likely to be seen, since the ejection unit 6 ejects the liquid 192 of the second color and the liquid 193 of the third color onto the medium 7, it is possible to prevent a decrease in visibility as compared with a case of a single color. That is, since the liquid 192 of the second color and the liquid 193 of the third color are mixed on the medium 7, it is possible to prevent a decrease in the visibility as compared with a case of a single color. In addition, it is possible to prevent a specific color from decreasing first.

(8) In the present embodiment, the control unit 22 can execute the mixed-color third mode 35 in the second mode 26.

In the mixed-color third mode 35, when the first detection unit 23 detects that the liquid amounts of the liquids 191, 192, 193 and 194 of all the colors fall below the predetermined amount Pa, the liquid 191 of the first color is ejected until the ejection unit 6 cannot eject the liquid 191. That is, the ejection of the liquid 191 of the first color until the idle ejection state is not performed until the liquid amounts of the liquids 191, 192, 193 and 194 of all the colors fall below the predetermined amount Pa. Accordingly, it is possible to reduce the risk of failure occurrence of the ejection unit 6.

When the ejection unit 6 cannot eject the liquid 191 of the first color, the ejection unit 6 ejects the liquid 192 of the second color and the liquid 193 of the third color onto the medium 7 instead of the liquid 191 of the first color. Then, when the ejection unit 6 enters the idle ejection state for the liquid 192 of the second color and the liquid 193 of the third color, the ejection unit 6 is caused to eject the liquid 194 of the fourth color until the ejection unit 6 enters the idle ejection state. Accordingly, since all of the liquids of multiple colors are used up until the ejection unit enters the idle ejection state, it is possible to improve the continuity of printing in an emergency or the like.

In addition, even when the liquid 192 of the second color alone is a color having low visibility with respect to the ground color of the medium 7, that is, a color that is less likely to be seen, since the ejection unit 6 ejects the liquid 192 of the second color and the liquid 193 of the third color onto the medium 7, it is possible to prevent a decrease in visibility as compared with a case of a single color. That is, since the liquid 192 of the second color and the liquid 193 of the third color are mixed on the medium 7, it is possible to prevent a decrease in the visibility as compared with a case of a single color. In addition, it is possible to prevent a specific color from decreasing first.

(9) In the present embodiment, the control unit 22 can execute the mixed-color fourth mode 36 in the second mode 26.

The mixed-color fourth mode 36 is configured to cause the ejection unit 6 to eject the liquid 192 of the second color and the liquid 19 of another color onto the medium 7 instead of the liquid 191 of the first color among the liquids 191, 192, 193 and 194 of multiple colors, that is, regardless of a remaining amount of the liquid 191 of the first color, when the brightness of the second color is closer to the brightness of the color of the medium 7 than the brightness of the first color and the brightness of the third color.

Accordingly, since the liquid 192 of the second color having low visibility is preferentially used in combination with the liquid 19 of another color, it is possible to prevent the liquid of a color that is less likely to be seen, that is, having low visibility, from remaining at the end. Therefore, the liquid 192 of a color having low visibility can also be used up until the ejection unit 6 enters the idle ejection state in a state where visibility is ensured by combining the liquid 192 with a liquid of another color.

(10) In the present embodiment, the control unit 22 can execute the mixed-color fifth mode 37 in the second mode 26.

The mixed-color fifth mode 37 is configured to cause the ejection unit 6 to eject the liquid 192 of the second color and the liquid 19 of another color among the liquids 191, 192, 193 and 194 of multiple colors onto the medium when the first detection unit 23 detects that the liquid amounts of the liquids 191, 192, 193 and 194 of all colors fall below the predetermined amount Pa. That is, the ejection of the liquid 192 of the second color and the liquid 19 of another color until the idle ejection state is not performed until the liquid amounts of the liquids 191, 192, 193 and 194 of all colors fall below the predetermined amount Pa. Accordingly, it is possible to reduce the risk of failure occurrence of the ejection unit 6.

The ejection unit 6 is caused to eject the liquid 192 of the second color with the liquid 19 of another color among the liquids 191, 192, 193 and 194 of multiple colors onto the medium 7 when the first detection unit 23 detects that the liquid amounts of the liquids 191, 192, 193 and 194 of all colors fall below the predetermined amount Pa. Further, the brightness of the second color is closer to the brightness of the color of the medium 7 than the brightness of other colors. In other words, the liquid 192 of the second color has the lowest visibility with respect to the ground color of the medium 7. However, the liquid 192 of the second color is ejected together with the liquid 19 of another color. Accordingly, since the liquid 192 of the second color having low visibility is preferentially used in combination with the liquid of another color, it is possible to prevent the liquid 192 of a color that is less likely to be seen, that is, having low visibility, from remaining at the end. Therefore, the liquid 192 of a color having low visibility can also be used up until the ejection unit 6 enters the idle ejection state in a state where visibility is ensured by combining the liquid 192 of a color having low visibility with the liquid 19 of another color.

(11) In the present embodiment, the control unit 22 can execute the mixed-color sixth mode 38 in the second mode 26.

The mixed-color sixth mode 38 causes the ejection unit 6 to eject the liquid 192 of the second color and the liquid 193 of the third color onto the medium 7 instead of the liquid 191 of the first color among the liquids 191, 192, 193 and 194 of multiple colors. Further, the liquid 191 of the first color is a black liquid. That is, the control unit 22 causes the ejection unit 6 to eject a liquid of a mixed color of the liquid 192 of the second color and the liquid 193 of the third color instead of black. Accordingly, it is possible to prevent consumption of the black liquid. It is expected that many of the media 7 used for printing in an emergency have colors other than black, particularly white. Therefore, it is possible to effectively use a black liquid having high visibility with respect to the media 7. A printed matter with good visibility can also be obtained without using a black liquid.

(12) In the present embodiment, the control unit 22 is configured to store, in the storage unit 39, information indicating that the ejection unit 6 cannot eject the liquid 19 in the second mode 26. Accordingly, information indicating that the idle ejection state occurs in the second mode 26 is stored in the storage unit 39, so that the information can be used for after service.

(13) In addition, in the present embodiment, the supply unit 21 includes the reservoir 24 that stores the liquid 19 from the liquid container 20. Further, the first detection unit 23 detects that a liquid amount in the reservoir 24 falls below the predetermined amount Pa. That is, since it is detected that the liquid amount in the reservoir 24 falls below the predetermined amount Pa, the liquid 19 in the liquid container 20 such as an ink cartridge can be used up to the maximum.

### Modification of Embodiment 1

In the modes 30, 31, 32, 33, 34, 35, 36, 37 and 38 of the present embodiment, when recording data is received, first, the liquid 191 of the first color is ejected from the ejection unit 6. That is, the recording data is executed as monochrome printing. However, the present disclosure is not limited thereto, and printing may be executed as color printing, and control of the modes 30, 31, 32, 33, 34, 35, 36, 37 and 38 may be executed only for a color for which the liquid cannot be ejected by the ejection unit or a color for which a liquid amount falls below the predetermined amount Pa.

In the single-color recording mode 28, the liquid 19 of a specific color may not be used. For example, the liquid 192 of the second color may not be used in the single-color recording mode 28.

In the modes 33, 34, 35, 36, 37 and 38 of the mixed-color recording mode 29, when it is detected that the ejection unit 6 enters the idle ejection state for the liquid 192 of the second color and the liquid 193 of the third color, the liquid 194 of the fourth color is ejected from the ejection unit 6, but the present disclosure is not limited thereto. When it is detected that the ejection unit 6 enters the idle ejection state for the liquid 192 of the second color, the liquid 193 of the third color and the liquid 194 of the fourth color may be ejected from the ejection unit 6, or the liquid 194 of the third color may be ejected from the ejection unit 6. When it is detected that the ejection unit 6 enters the idle ejection state for the liquid 193 of the third color, the liquid 192 of the second color and the liquid 194 of the fourth color may be ejected from the ejection unit 6.

In the mixed-color third mode 35, recording is executed by causing the ejection unit 6 to sequentially eject the liquids of the four colors one by one, but the present disclosure is not limited thereto. That is, the liquid 19 of a specific color may not be used. For example, the liquid 192 of the second color may be used only when colors are mixed.

### Embodiment 2

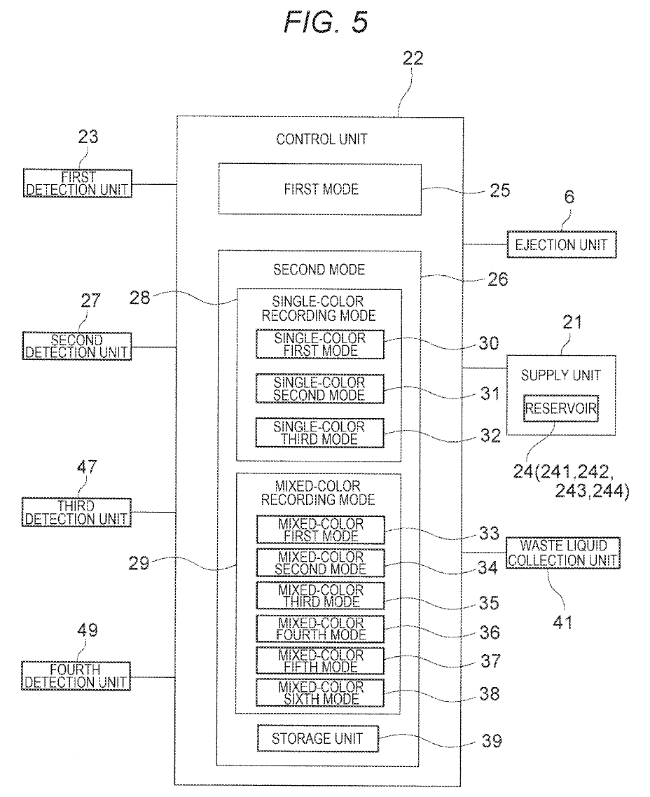

Next, a recording apparatus according to Embodiment 2 will be described with reference to FIGS. 4 and 5. The same portions as the portions in Embodiment 1 are denoted by the same reference numerals and signs and description of configurations and effects corresponding thereto is omitted.

In the present embodiment, the cap 18 and a waste liquid container 40 communicate with each other through a flow path 43. The waste liquid container 40 receives and stores a waste liquid 42 of ink in the cap 18. The waste liquid 42 in the cap 18 is sent into the waste liquid container 40 by a pump 44.

Ink ejected to a receiving portion (not illustrated) in borderless printing is also sent into the waste liquid container 40. It is desirable that the waste liquid 42 of the ink received by the receiving portion is filtered by a filter or the like and sent to the waste liquid container 40.

That is, a waste liquid collection unit 41 that collects the waste liquid 42 discharged from the ejection unit 6 and stores the waste liquid 42 in the waste liquid container 40 is provided.

In the present embodiment, the control unit 22 is configured to return the waste liquid 42 collected by the waste liquid collection unit 41 to the reservoir 24 in the second mode 26. In FIG. 4, a reference numeral 45 denotes a return flow path. The return flow path 45 is provided with a liquid feed pump (not illustrated), and is configured to return the liquid when a control signal is sent from the control unit 22. The liquid may be directly returned from the flow path 43 to the reservoir 24, or may be returned from a second waste liquid container 46 to be described later to the reservoir 24.

That is, in an emergency, the waste liquid 42 can be used as ink for executing recording.

The reservoir 24 where the liquid is to be returned may be all or some of the plurality of reservoirs 241, 242, 243 and 244. Alternatively, the liquid may be returned only to the black reservoir 241.

Further, the waste liquid 42 to be returned to the reservoir 24 may be limited to only a specific waste liquid having a small amount of foreign matters, such as only an ink waste liquid obtained by flushing or only an ink waste liquid obtained by cleaning.

As illustrated in FIG. 5, in the present embodiment, a third detection unit 47 that detects that a liquid amount in the waste liquid container 40 exceeds an allowable amount is further provided. The third detection unit 47 only needs to detect the fact indicating that the liquid amount in the waste liquid container 40 exceeds the allowable amount, and the fact may be detected by a mechanical sensor or may be calculated and obtained based on a liquid feeding amount of the pump 44 or a control count value.

In the present embodiment, the control unit 22 is configured to continue the ejection of the liquid 19 by the ejection unit 6 even when the third detection unit 47 detects the fact indicating that the liquid amount in the waste liquid container 40 exceeds the allowable amount in the second mode 26.

That is, in an emergency, even when the waste liquid 42 leaks out from the waste liquid container 40, the waste liquid 42 does not flow out to the outside of the recording apparatus 1 for a while, and thus the recording can be continued even in this state.

As illustrated in FIGS. 4 and 5, in the present embodiment, a housing 48 (FIG. 4) constituting the appearance of the recording apparatus 1 and a fourth detection unit 49 (FIG. 5) that detects the waste liquid 42 leaking to the outside of the housing 48 are further provided. The fourth detection unit 49 detects the waste liquid 42 leaking to the outside of the housing 48. Therefore, a plurality of portions are arranged below a bottom portion 50 of the housing. The fourth detection unit 49 may be a sensor capable of detecting a physical change caused by a fluid flowing into a place where no fluid is present.

In the present embodiment, the control unit 22 is configured to stop the ejection of the liquid 19 by the ejection unit 6 when the fourth detection unit 49 detects the waste liquid 42 in the second mode 26. That is, in an emergency, the ejection of the liquid 19 is stopped in consideration of protection of the surrounding environment in which the recording apparatus 1 is placed.

As illustrated in FIG. 5, in the present embodiment, the second waste liquid container 46 that can store the waste liquid 42 is further provided. The second waste liquid container 46 communicates with the flow path 43 via a flow path switching valve 52.

In FIG. 4, a reference numeral 53 denotes a return flow path from the second waste liquid container 46 to the reservoir 24. The return flow path 53 is provided with a liquid feed pump (not illustrated), and is configured to return the liquid when a control signal is sent from the control unit 22.

In the second mode 26, the control unit 22 is configured to store the waste liquid 42 collected by the waste liquid collection unit 41 in the second waste liquid container 46 when the third detection unit 47 detects the fact indicating that the liquid amount in the waste liquid container 40 exceeds the allowable amount.

As illustrated in FIG. 4, a plug 54 that receives power supply is further provided in the present embodiment. The plug 54 is generally coupled to a commercial power supply 55. In the present embodiment, when a battery 56 is separately provided, power can be supplied from the battery 56. The battery 56 is, for example, a portable battery that can be carried in an emergency. The control unit 22 is configured to distinguish between a state where the plug 54 is supplied with power from the commercial power supply 55 and a state where the plug is supplied with power from the battery 56.

In the present embodiment, the control unit 22 is configured to execute the first mode 25 when the plug 54 is supplied with power from the commercial power supply 55, and execute the second mode 26 when the plug 54 is supplied with power from the battery 56. That is, in an emergency, a power failure may occur, and in this case, when the battery 56 is coupled to the plug 54, the second mode 26 is automatically switched to a usable state.

The plug 54 may be combined with the recording apparatus 1 according to Embodiment 1.

### Description of Control Flow according to Embodiment 2

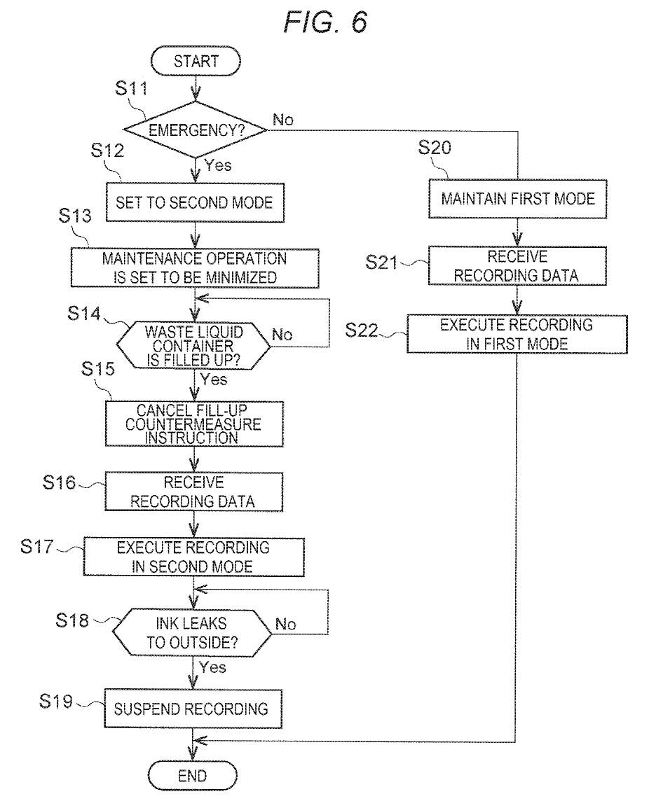

A control flow according to Embodiment 2 will be described with reference to FIG. 6.

Step S11, step S12, and step S13 are the same as step S1, step S2, and step S3 in FIG. 3 of Embodiment 1, and step S20, step S21, and step S22 are the same as step S6, step S7, and step S8 in FIG. 3 of Embodiment 1, and thus description thereof will be omitted.

In step S14, when the waste liquid container 40 is filled up according to detection information of the third detection unit 47 (Yes), the control flow proceeds to step S15. In step S15, a fill-up countermeasure is canceled. Here, the fill-up countermeasure refers to that a user is notified that the waste liquid container 40 is filled up, and when the waste liquid container 40 is not replaced thereafter, the ejection unit 6 becomes unable to eject the liquid before the waste liquid leaks out from the waste liquid container 40. In the second mode 26, the ejection can be continued regardless of the fill-up countermeasure.

Subsequently, the control flow proceeds to step S16, and when recording data for printing is received, the control flow proceeds to step S17, and recording is executed in the second mode 26. Specifically, one of the nine control modes 30, 31, 32, 33, 34, 35, 36, 37 and 38 of the second mode 26 illustrated in FIG. 5 is executed. That is, the recording is executed in a state where the continuity of printing in which ink is used up is prioritized over the reduction of the risk of failure occurrence of the ejection unit 6.

Subsequently, the control flow proceeds to step S18, and when the waste liquid 42 of ink leaks to the outside of the recording apparatus 1, that is, to the outside of the apparatus according to detection information of the fourth detection unit 49, the control flow proceeds to step S19, and the ejection by the ejection unit 6 is stopped, that is, recording is suspended.

### Description of Effects of Embodiment 2

(1) In the present embodiment, the control unit 22 is configured to return the waste liquid 42 collected by the waste liquid collection unit 41 to the reservoir 24 in the second mode 26. Accordingly, since the waste liquid 42 is returned to the reservoir 24, necessity of paying attention to a capacity of the waste liquid container 40 is reduced. Further, since an amount of the liquid 19 such as ink used for printing can be increased, the continuity of printing can be more effectively increased.

(2) In the present embodiment, the control unit 22 is configured to continue the ejection of the liquid 19 by the ejection unit 6 even when the third detection unit 47 detects the fact indicating that the liquid amount in the waste liquid container 40 exceeds the allowable amount Pa in the second mode 26. Accordingly, even when the waste liquid container 40 is filled up, the leaked waste liquid 42 does not immediately flow out to the outside of the recording apparatus 1, and thus, in an emergency, it is possible to improve the continuity of printing by continuing printing in this state.

(3) In the present embodiment, the fourth detection unit 49 that detects the waste liquid 42 leaking to the outside of the housing 48 is further provided, and the control unit 22 is configured to stop the ejection of the liquid 19 by the ejection unit 6 when the fourth detection unit 49 detects the waste liquid 42 in the second mode 26. Accordingly, when the waste liquid 42 leaks to the outside of the housing 48, that is, to the outside of the apparatus, it is possible to prevent the failure occurrence outside the apparatus by stopping the ejection of the liquid 19.

(4) In the present embodiment, the control unit 22 is configured to store the waste liquid 42 collected by the waste liquid collection unit 41 in the second waste liquid container 46 when the third detection unit 47 detects the fact indicating that the liquid amount in the waste liquid container 40 exceeds the allowable amount in the second mode 26. Accordingly, even when the waste liquid container 40 is filled up, it is possible to continue printing by delaying the occurrence of liquid leakage to the outside of the apparatus by returning the waste liquid 42 to the spare second waste liquid container 46.

(5) In the present embodiment, the control unit 22 is configured to execute the first mode 25 when the plug 54 is supplied with power from the commercial power supply 55, and execute the second mode 26 when the plug 54 is supplied with power from the battery 56. Accordingly, by executing the first mode 25 when the general commercial power supply 55 is used and executing the second mode 26 when power is supplied from the battery 56, it is possible to reduce the possibility that the second mode 26 is erroneously executed in a regular state.

### Other Embodiments

The recording apparatus 1 according to the present disclosure is based on the configurations of the embodiments described above, and it is needless to say that a partial configuration can be changed or omitted without departing from the gist of the present disclosure.

(1) In the embodiments described above, a case where the colors of the liquid such as ink are multiple colors, that is, four colors has been described, but the colors are not limited to four colors. Two colors, three colors, six colors, or the like may be used. In addition, one color may be used instead of multiple colors. The color mixture is not limited to a mixture of two colors, and may be a mixture of three or more colors.

(2) In the embodiments described above, the second mode 26 includes the nine control modes 30, 31, 32, 33, 34, 35, 36, 37 and 38, but the second mode 26 may not include all of the nine control modes. One or more of the nine control modes may be provided.

What is claimed is:

1. A recording apparatus that performs recording by ejecting a liquid onto a medium, the recording apparatus comprising:
an ejection unit configured to eject the liquid onto the medium;
a supply unit configured to supply the liquid from a liquid container to the ejection unit;
a first detection unit configured to detect that an amount of the liquid inside the liquid container or inside the supply unit falls below a predetermined amount; and
a control unit configured to control the ejection unit, wherein
the control unit is configured to execute
a first mode in which ejection of the liquid onto the medium by the ejection unit is restricted when the first detection unit detects the fact indicating that the amount of the liquid falls below the predetermined amount, and
a second mode in which the ejection of the liquid onto the medium by the ejection unit is not restricted until the ejection unit becomes unable to eject the liquid.

2. The recording apparatus according to claim 1, wherein
the ejection unit is configured to eject liquids of multiple colors, and
the control unit causes, in the second mode, the ejection unit to eject, among the liquids of multiple colors, a liquid of a second color onto the medium instead of a liquid of a first color when the ejection unit becomes unable to eject the liquid of the first color.

3. The recording apparatus according to claim 1, wherein
the ejection unit is configured to eject liquids of multiple colors, and
the control unit causes, in the second mode, the ejection unit to eject, among the liquids of multiple colors, a liquid of a second color and a liquid of a third color onto the medium instead of a liquid of a first color when the ejection unit becomes unable to eject the liquid of the first color.

4. The recording apparatus according to claim 1, wherein
the ejection unit is configured to eject liquids of multiple colors, and
the control unit causes, in the second mode, the ejection unit to eject, among the liquids of multiple colors, a liquid of a second color onto the medium instead of a liquid of a first color when the first detection unit detects that an amount of the liquid of the first color falls below the predetermined amount.

5. The recording apparatus according to claim 1, wherein
the ejection unit is configured to eject liquids of multiple colors, and
the control unit causes, in the second mode, the ejection unit to eject, among the liquids of multiple colors, a liquid of a second color and a liquid of a third color onto the medium instead of a liquid of a first color when the first detection unit detects that an amount of the liquid of the first color falls below the predetermined amount.

6. The recording apparatus according to claim 1, wherein
the ejection unit is configured to eject liquids of multiple colors, and
the control unit causes, in the second mode, the ejection unit to eject a liquid of a second color onto the medium instead of a liquid of a first color when the first detection unit detects that liquid amounts of the liquids of all the colors fall below the predetermined amount and further the ejection unit becomes unable to eject the liquid of the first color.

7. The recording apparatus according to claim 1, wherein
the ejection unit is configured to eject liquids of multiple colors, and
the control unit causes, in the second mode, the ejection unit to eject a liquid of a second color and a liquid of a third color onto the medium instead of a liquid of a first color when the first detection unit detects that liquid amounts of the liquids of all the colors fall below the predetermined amount and further the ejection unit becomes unable to eject the liquid of the first color.

8. The recording apparatus according to claim 3, wherein
brightness of the second color is closer to brightness of a color of the medium than brightness of the first color and brightness of the third color.

9. The recording apparatus according to claim 1, wherein
the ejection unit is configured to eject liquids of multiple colors,
the control unit causes, in the second mode, the ejection unit to eject, among the liquids of multiple colors, a liquid of a second color and a liquid of another color onto the medium instead of a liquid of a first color, and
brightness of the second color is closer to brightness of a color of the medium than brightness of all other colors.

10. The recording apparatus according to claim 1, wherein
the ejection unit is configured to eject liquids of multiple colors, and
the control unit causes, in the second mode, the ejection unit to eject, among the liquids of multiple colors, a liquid of a second color and a liquid of another color when the first detection unit detects that liquid amounts of the liquids of all the colors fall below the predetermined amount, and
brightness of the second color is closer to brightness of a color of the medium than brightness of all other colors.

11. The recording apparatus according to claim 1, wherein
the ejection unit is configured to eject liquids of multiple colors,
the control unit causes, in the second mode, the ejection unit to eject, among the liquids of multiple colors, a liquid of a second color and a liquid of a third color onto the medium instead of a liquid of a first color, and
the liquid of the first color is a black liquid.

12. The recording apparatus according to claim 1, further comprising:
a storage unit, wherein
the control unit, in the second mode, stores, in the storage unit, information indicating that the ejection unit becomes unable to eject the liquid.

13. The recording apparatus according to claim 1, wherein
the supply unit includes a reservoir that stores the liquid from the liquid container, and
the first detection unit detects that a liquid amount in the reservoir falls below the predetermined amount.

14. The recording apparatus according to claim 1, wherein
the supply unit includes a reservoir that stores the liquid from the liquid container,
the recording apparatus further includes a waste liquid collection unit configured to collect a waste liquid discharged from the ejection unit and store the waste liquid in a waste liquid container, and
the control unit returns, in the second mode, the waste liquid collected by the waste liquid collection unit to the reservoir.

15. The recording apparatus according to claim 1, further comprising:
a waste liquid collection unit configured to collect a waste liquid discharged from the ejection unit and store the waste liquid in a waste liquid container; and
a third detection unit configured to detect that a liquid amount in the waste liquid container exceeds an allowable amount, wherein
the control unit continues, in the second mode, the ejection of the liquid by the ejection unit even when the third detection unit detects the fact indicating that the liquid amount in the waste liquid container exceeds the allowable amount.

16. The recording apparatus according to claim 15, further comprising:
a housing constituting an appearance of the recording apparatus; and
a fourth detection unit configured to detect the waste liquid leaking to an outside of the housing, wherein
the control unit stops, in the second mode, the ejection of the liquid by the ejection unit when the waste liquid is detected by the fourth detection unit.

17. The recording apparatus according to claim 1, further comprising:
a waste liquid collection unit configured to collect a waste liquid discharged from the ejection unit and store the waste liquid in a waste liquid container;
a third detection unit configured to detect that a liquid amount in the waste liquid container exceeds an allowable amount; and
a second waste liquid container configured to store the waste liquid, wherein
the control unit causes, in the second mode, the second waste liquid container to store the waste liquid collected by the waste liquid collection unit when the third detection unit detects the fact indicating that the liquid amount in the waste liquid container exceeds the allowable amount.

18. The recording apparatus according to claim 1, further comprising:
a plug configured to receive power supply, wherein
the control unit is configured to
execute the first mode when the plug is supplied with power from a commercial power supply, and
execute the second mode when the plug is supplied with power from a battery.

19. A control method of a recording apparatus that performs recording by ejecting a liquid onto a medium,
the recording apparatus including
an ejection unit configured to eject the liquid onto the medium,
a supply unit configured to supply the liquid from a liquid container to the ejection unit, and
a first detection unit configured to detect that an amount of the liquid inside the liquid container or inside the supply unit falls below a predetermined amount,
the control method comprising:
executing a first mode in which ejection of the liquid onto the medium by the ejection unit is restricted when the first detection unit detects the fact indicating that the amount of the liquid falls below the predetermined amount; and
executing a second mode in which the ejection of the liquid onto the medium by the ejection unit is not restricted until the ejection unit becomes unable to eject the liquid.
